(19) United States
(12) Patent Application Publication
(10) Pub. No.: US 2002/0056001 A1
(43) Pub. Date: May 9, 2002

(54) Communication security system

(76) Inventors: Stephen D. Magee, Scottsdale, AZ (US); Erwin P. Comer, Queen Creek, AZ (US); Jin Yang, Maidenhead, Berks (GB)

Correspondence Address: MOTOROLA, INC., CORPORATE LAW DEPARTMENT - #56-238, 3102 NORTH 56TH STREET, PHOENIX, AZ, 85018, US

(21) Appl. No.: 09/920,198

(22) Filed: Aug. 1, 2001

Related U.S. Application Data
(60) Provisional application No. 60/247,181, filed on Nov. 9, 2000.

(51) Int. Cl. G06F 15/173

(52) U.S. Cl. 709/225; 455/410

(57) ABSTRACT

User (113) requests multimedia services from a visited network (129). The user's home network (101) dynamically establishes a secure call control link between two prior negotiated call stat control function units (305) and (315).

### BACKGROUND OF THE INVENTION

The present invention pertains to a multimedia communication interface and more particularly to a secure, real time communication interface which is established between a user and a network.

With the proliferation of wireless communication, wireless communications are being adapted to internet applications. Because wireless communications broadcast over the air, such communications are particularly susceptible to interception and misuse. Large amounts of highly proprietary or confidential data may be transmitted to a wireless user via an internet protocol arrangement. As a result, this confidential data may be readily compromised.

Accordingly, what is needed is a secure, real time communication interface between users and multimedia networks employing internet protocol.

### BRIEF DESCRIPTION OF THE DRAWING

FIG. 1 is a block diagram of a prior art wireless, multimedia network arrangement for supporting internet protocol for the wireless transmission of data.

FIG. 2 is a block diagram of a wireless, multimedia network interface for supporting internet protocol in accordance with the present invention.

FIG. 3 is a block diagram of a security interface arrangement in accordance with the present invention.

### DESCRIPTION OF THE PREFERRED EMBODIMENT

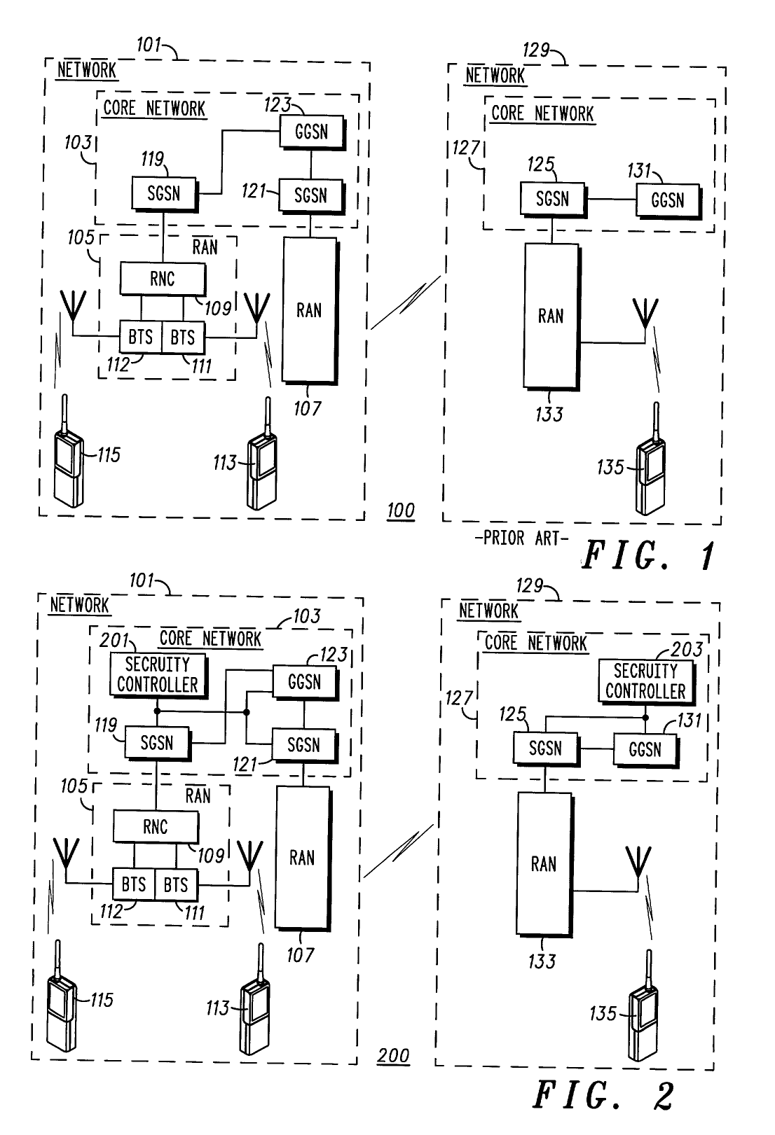

FIG. 1 shows a wireless network arrangement 100 for facilitating internet access for mobile users. The arrangement 100 includes two networks 101 and 129 which may be in communication with one another via wireless or wire line access. Network 101 includes a core network 103 and similarly network 129 includes a core network 127. Core network 103 includes a GGSN 123 (a gateway GPRS service node) (GPS being general packet radio services). One or more SGSNs signaling GPS service node) 119 and 121 are coupled to GGSN 123. Similarly, SGSN 125 is shown coupled to GGSN 131 in core network 127.

Each SGSN is coupled to a RAN (Radio Access Network). RAN 105 is coupled to SGSN 119 and RAN 107 is coupled to SGSN 121. Similarly, in network 129 SGSN 125 is coupled to RAN 133.

The details of RAN 105 are depicted. RAN 105 includes a remote network controller (RNC) 109 which is coupled to many base stations. For example, base stations (BTS) 111 and 112 are shown coupled to RNC 109. Mobile users 113 and 115 are depicted as wirelessly coupled to base stations 111 and 112 respectively. Each base station may connect to many, many users. Lastly, mobile 135 is shown coupled to RAN 133 in network 129. As a result, telecommunications may take place between mobiles 113, 115 and 135 via the networks shown in FIG. 1.

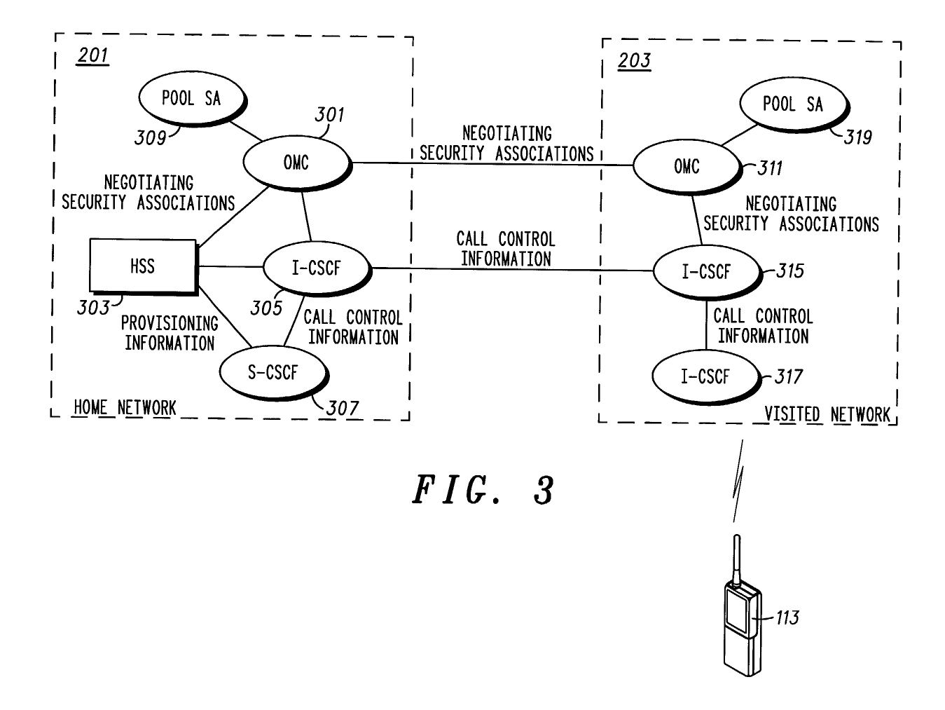

FIG. 2 depicts a block diagram of the communication arrangement 200 with multimedia internet protocol security. Communication arrangement 200 is similar to communication arrangement 100 of FIG. 1. However, core networks 103 and 127 include security controllers 201 and 203 respectively. This arrangement supports an approach for standardization of universal mobile telecommunications system (UMTS) as well as applications to 3GPP multimedia.

In the present embodiment the first network is owned and operated by a first operator whereas the second network may be owned and operated by a second operator.

The network elements may be a GGSN and a SGSN as envisaged for packet based services for UMTS but can in principle be any network element including both packet switched and network switched network elements. The connection between the network elements is preferably established through a public SS7 network or IP networks and using the MAP protocol. The MAP protocol is a core network signaling protocol utilized by GSM and UMTS circuit switched mode. It is based on the SS7 signaling system. A person skilled in the art will appreciate that any physical or virtual connection can be used without detracting from the invention.

Public networks and in particular SS7 and IP (internet protocol) networks are not secure and therefore any communication between the first and second network elements should include security features ensuring that the communication is resistant to attacks. However, if these security features are established directly between the communicating network elements, the complexity of the network elements is increased to the additional required functionality. As each network typically comprises a high number of network elements this leads to a substantial total complexity increase of the network.

In accordance with a preferred embodiment, this is achieved by the first and second security controllers 201 and 203 establishing both a security key and a security mechanism and communicating these to the first and second network elements. The first and second network elements 119 and 125 communicate with each other using the security key and security mechanism.

In the preferred embodiment, the communication between the first and second network element is through an IP (Internet Protocol)network. A security framework known as IP security has been standardized for IP networks. It is called a framework because it comprises various protocol and algorithm options for encryption, integrity check and authentication. These IP security mechanisms utilize symmetric-security key technologies, for example, which means both communication parties use a shared secret key for encryption, integrity check and packet-authentication although each service utilizes a unique key.

IP specifies many alternatives and options and therefore for two communicating parties, 115 and 135 for example, to communicate securely they should establish a common set of security mechanisms including security protocols and algorithms. In addition, the security key is established to provide secure communication when used with the mechanisms. The established keys together with the agreement security mechanisms are called an IP Security Association (SA).

In order for the first and second network elements 119 and 125 to communicate securely not only the security key but also the security mechanism established by the central security controllers and distributed to the network elements. The entire IP Security Association is thus distributed to the network elements as described in the following.

Each network, or alternatively each independent sub network, has a centralized security controller 201, 203, for example. When the first network element 123 needs to communicate with the second network element 125, the security controllers 201 and second 203 communicate in order to establish an entire IP Security Association. It will be apparent that the security controllers may communicate through a dedicated connection, a virtual connection through a network or any other connection allowing data to be exchanged between the communication units 115 and 135. The security controllers 201, 203 can use any known method for establishing Security Association between two communicating units 115 and 135. The Security Association established includes symmetric keys and the security mechanisms including all necessary protocols and algorithms.

The entire Security Association is subsequently downloaded to the SGSN network elements 119 and 125. These then proceed to set up and carry out the desired communication using the entire Security Association including both security mechanisms and security keys. When the communication terminates, the security controllers 201 and 203 are informed and the Security Association can be terminated thereby freeing up resources.

As the Security Association is established centrally between security controllers 201 and 203, the key management and security mechanism establishment can be off loaded from the network elements such as GGSNs or SGSNs. This reduces the complexity and cost of these network elements and as a typical network comprises many such network elements a substantial overall complexity reduction is achieved.

In addition, because the entire Security Association is established and distributed to the network elements the security of the link between the two elements is identical to that which can be achieved between two network elements directly establishing a Security Association between them.

As an example, in the preferred embodiment, the Security Association includes defining a playback security mechanism. This mechanism operates by having a Sequence Number Counter (SNC) running independently at both the first and second network elements (SGSNs). The SNC's are at given times set to the same sequence number by the Security Associations received from the security controllers 201 and 203. The transmitting network element 119 includes the current sequence number and when received the receiving network element 125 compares this sequence number to the value of its own SNC. The receiving network element 125 will then only accept the communication if the received sequence number fits within an anti-replay window. By establishing this mechanism including a sequence number and an anti-replay window within the Security Association, the two network elements 119 and 125 are able to provide this anti-replay mechanism. In contrast, if only security keys were distributed this would only enable verification of the communication being from the correct source, but not provide any anti-replay protection.

It will be appreciated that the description has specifically considered communication between two independent networks 101 and 129 owned by different operators. However the principle may be applicable to any network or sub-network, where security controllers negotiate security mechanisms and communicates these to the network elements which uses them for the communication.

The present discussion has specifically considered a UMTS packet switched network including SGSN and GGSN network elements. However, it will be apparent to a person ordinarily skilled in the art that the invention is applicable to a wide variety of networks including Local Area Networks, Internet networks and others. Likewise, the invention is equally applicable to circuit switched networks. The invention can thus be applied to the circuit switched elements of a GSM or UMTS network and specifically the first and second network elements can, for example, be base stations, Base Station Controllers, Master Switch Centers, Home Location Registers or Visitor Location Registers.

The multimedia domain currently under development by 3GPP is based on an IP infrastructure. The Call Agent in the 3GPP architecture, known as the Call State Control Function (CSCF), is the call-processing engine for the multimedia domain. There are three roles that the CSCF plays in this architecture.

The first role is a serving CSCF (S-CSCF). One Serving CSCF is allocated to each registered user and executes all services for that user. The user's S-CSCF resides in either the home or visited network.

The second role is a proxy CSCF (P-CSCF). One Proxy CSCF is allocated to each registered user when that user is registered in a visited network. The P-CSCF establishes the trust relationship between the visited network and the user and provides emergency services for the user.

The third role is an interrogating CSCF (I-CSCF). The I-CSCF is used for routing mobile terminated calls. It also serves as the CSCF Network Access Point, hiding the addresses of the other S-CSCFs and P-CSCFs from other network operators.

Referring to FIG. 3, security controllers 201 and 203 of networks 101 and 129 are shown in block diagram. Typically, a user 113 would be associated with its home network 101. In the scenario of FIG. 3, user 113 would be seeking multimedia services in a 3GPP architecture in which user 113 is making a request through visited network 129. Visited network 129 must securely handshake with home network 101 to ensure proper handling and security of the multimedia request of user 113.

The security association of the present invention is distributed in real time during registration as part of a proxy CSCF and a serving CSCF allocation. A pool of security associations is pre-established between the OMCs (Operations and Maintenance Centers) 311 and 301 of the visited network 129 and home network 101 for rapid allocation.

User 113, for example, is registered in the visited network 129. The serving CSCF 307 has previously been allocated in the home network 101. The proxy CSCF 317 in the visited network 129 handles the origination requesting service by user unit 113.

Proxy CSCF 317 obtains information about the services user 113 is requesting and transmits this call control information through interrogating CSCF 315 to an interrogating CSCF 305 in the user's 113 home network 101. Interrogating CSCF 305 transmits this call information to serving CSCF 307. Call control information then flows freely between the serving CSCF 307 and the proxy CSCF 317 via the interrogating CSCFs 305 and 315. Provisioning information is transmitted from HSS (Home Subscriber Server) 303 to the servicing CSCF 307.

In the 3G multimedia domain, user 113 may be provided internet protocol security although dynamic allocation of proxy CSCFs and serving CSCFs result. The allocation of proxy and servicing CSCFs is established during registration of user 113 in a visited network 129. This established security exists only for the duration of the user's registration in the visited network 129. When the user 113 roams into another network (not shown) and registers in that network, it is possible that the user would be assigned a different proxy CSCF and servicing CSCF. Therefore, as the user roams, the internet protocol security associations are changed dynamically. A pool of security associations (SAs) for proxy CSCFs and servicing CSCFs 309 and 319 are created in each of the networks.

Each OMC 301 and 311 therefore creates a security association for each proxy CSCF and servicing CSCF. These security associations are negotiated by the OMCs 301 and 311 prior to use by user 113. As a result, all networks 101 and 129 (and others not shown) have prenegotiated security associations (SAs) for each of the CSCFs needed to serve roaming users such as user 113.

For example, when user 113 registers in a visited network 129, the user locates the proxy CSCF 317. The criteria for selecting a proxy CSCF includes the home network 101 identity of the roaming user. As a result, at least one of the proxy CSCFs in the pool 319 has a previously negotiated security association to be allocated to user 113.

As the user 113 registration process continues, the interrogating CSCF 305 in the home network 101 chooses the servicing CSCF 307 and associates that serving CSCF with the user. The interrogating CSCF 305 selects servicing CSCF 307 from the pool of CSCFs with security associations 309. Hence, a CSCF which has previously negotiated security associations with visited network 129, is selected for allocation to user 113. OMC 301 then passes the serving CSCF 307 security association to the HSS 303. This provides HSS 303 with a secure interface to download provisioning information to the servicing CSCF 307 which then transmits this information through interrogating CSCFs 305 and 315 to proxy CSCF 317 to assist in handling user 113's request for secure internet protocol services.

By using CSCFs from the pool 309, security associations are created in real time although previously negotiated between OMCs 301 and 311 of the networks 101 and 129. Hence, a secure communication path is provided between the proxy and servicing CSCFs 317 and 307 and HSS 303.

As can be noted from the above explanation, the present invention provides a fast, secure, real time communication interface between a user and network elements for service requests in a 3GPP multimedia domain.

Although the preferred embodiment of the invention has been illustrated, and that form described in detail, it will be readily apparent to those skilled in the art that various modifications may be made therein without departing from the spirit of the present invention or from the scope of the appended claims.

1. A secure communication system comprising:
a first network having a first security controller and a plurality of first network elements connected to said first security controller;
a second network having a second security controller and a plurality of second network elements connected to said second security controller;
a user requesting secure multimedia services in the second network, said first network being the user's home network;
said first security controller selecting one of the plurality of first network elements for coupling to the second network; and said second security controller selecting one of the plurality of second network elements for dynamically coupling to the selected one of the plurality of first network elements.

2. The secure communication system as claimed in claim 1, wherein said dynamic coupling between said selected ones of the first and second pluralities of network elements is over an Internet Protocol connection.

3. The secure communication system as claimed in claim 1, wherein said first and second security controllers pre-negotiate an internet protocol security for the selected ones of the pluralities of first and second network elements.

4. The secure communication system as claimed in claim 1, wherein the first security controller establishes a security association for said plurality of first network elements with a plurality of networks.

5. The secure communication system as claimed in claim 1, wherein the second security controller establishes a security association of the plurality of second network elements with a plurality of networks.

6. The secure communication system as claimed in claim 1, wherein the plurality of first network elements includes a plurality of call state control function units.

7. The secure communication system as claimed in claim 1, wherein the plurality of second network elements includes a plurality of call state control function units.

8. The secure communication system as claimed in claim 1, wherein the secure communication system is a 3GPP multimedia communication system.

9. The secure communication system as claimed in claim 1, wherein the secure communication system is a UMTS (Universal Mobile Telecommunication System).

10. A method for secure communication in a communication system, the communication system including home and visited networks having respective pluralities of first and second network elements and a first and second security controller, the method for secure communication comprising the steps of:
assigning a user to the home network;
requesting by the user secure multimedia services from the visited network;
selecting by the visited network one of said plurality of second network elements;
selecting by the home network one of the plurality of first network elements in response to the step of requesting by the user; and
dynamically coupling the selected ones of the pluralities of first and second network elements to provide secure multimedia services to the user.

11. The method for secure communication as claimed in claim 10, wherein there is further included prior to the step of requesting, negotiating a security association between the selected ones of the pluralities of first and second selected network elements.

12. The method for secure communication as claimed in claim 10, wherein there is further included prior to the step of requesting, negotiating by the home network security associations between each of the plurality of first network elements and a plurality of visited networks, each of the plurality of visited networks having a plurality of second network elements.

13. The method for secure communication as claimed in claim 12, wherein there is further included the step of pooling by the home network each of said plurality of first network elements having a negotiated security association.

14. The method for secure communication as claimed in claim 12, wherein there is further included the step of pooling by each of the plurality of visited networks the plurality of second network elements having a security association.

15. The method for secure communication as claimed in claim 10, wherein the step of dynamically coupling the pluralities of first and second network elements includes the step of dynamically coupling over an internet protocol connection.

16. The method for secure communication as claimed in claim 11, wherein the step of dynamically coupling includes the steps of:
selecting by the home network a first network element having a security association with the visited network;
selecting by the visited network a second network element having a security association with the home network; and
coupling the selected ones of the pluralities of first and second network elements.

17. The method for secure communication as claimed in claim 10, wherein there is further included the step of providing a call state control function unit for each of said plurality of first network elements.

18. The method for secure communication as claimed in claim 10, wherein there is further included the step of providing a call state control function unit for each of the plurality of second network elements.

19. The method for secure communication as claimed in claim 10, wherein the communication system comprises a secure 3GPP multimedia communication system.

20. The method for secure communication as claimed in claim 10, wherein the communication system comprises a secure universal mobile telecommunication system.
